(19) United States
(12) Patent Application Publication
(10) Pub. No.: US 2008/0273123 A1
(43) Pub. Date: Nov. 6, 2008

(54) Laser Picture Formation Device

(75) Inventors: Akihiro Morikawa, Osaka (JP); Ken'ichi Kasazumi, Osaka (JP); Tetsuro Mizushima, Osaka (JP); Kazuhisa Yamamoto, Osaka (JP); Shin-ichi Kadowaki, Hyogo (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 12/064,373

(22) PCT Filed: Sep. 14, 2006
(86) PCT No.: PCT/JP2006/318238

§ 371 Date: Feb. 21, 2008

(30) Foreign Application Priority Data
Sep. 14, 2005 (JP) 2005-266527

(51) Int. Cl. H04N 5/74

(52) U.S. Cl. 348/757; 348/E05.137

(57) ABSTRACT

In a laser picture formation device which forms a vide image by irradiating lights emitted from plural laser light sources (1a, 1b, 1c) which obtains monochromatic lights from laser lights which are outputted from the respective laser light emission parts to spatial light modulators (5a, 5b, 5c), each of the plural laser light sources (1a, 1b, 1c) detect the output of laser light which is emitted from the respective laser light emission parts on the basis of the modulation input signal which for modulating the spatial light modulator. Thereby, it is possible to confirm the deterioration situation of the respective laser light emission parts without deteriorating the video images which are projected onto the screen, as well as without separating the synthesized light respectively.

### TECHNICAL FIELD

The present invention relates to a laser picture formation device for forming a picture using a laser light source. More particularly, it relates to a laser picture formation device which forms a picture with using light sources that detect and control the light quantity of a plurality of laser beams which are emitted from a plurality of lasers.

### BACKGROUND ART

FIG. 11 is a diagram illustrating a schematic construction of a laser display. Laser lights from the RGB (R: red, G: green, and B: blue) three color laser light sources 101a to 101c are at first beam expanded by the expander optical system 102. Next, the expanded laser lights are beam formed by the integrator optical system 103 which is constituted by a lens and a small-sized lens array, so as to be uniformly irradiated to the spatial light modulators 105a to 105c, respectively. The laser lights are intensity modulated by the spatial optical modulators 105a to 105c, respectively, in accordance with the input video signal and they are synthesized by the dichroic prism 106 together. The intensity modulated lights are expanded by the projection lens 107, and two-dimensional images are displayed on the screen 108. The display device of this construction includes the RGB laser light sources which respectively emit monochromatic lights, and when the laser light sources of appropriate wavelengths are employed, the display of video images having a high purity and having vivid images can be realized.

In such a laser picture formation device, in order to realize a higher brightness image or an enhanced size display, a larger light intensity is required, and therefore, it would be effective to adopt a method of employing, not only a laser light source, but a plurality of laser Tight sources and controlling the same in respective wavelengths of RGB.

In this case, however, in order to detect failures in plural laser light sources, a detector has to be provided for each of the laser light sources, thereby resulting in a high cost.

Noting the above, a laser picture formation device which employs a plurality of semiconductor lasers and thereby has reduced the number of detectors is disclosed in patent document 1. In this patent document 1, a method in which plural laser light emission parts are operated in a time divisional manner and the laser deterioration is detected by a single photo detector is disclosed.

In the laser picture formation device which employs plural laser light emission parts in each of the respective wavelengths which is disclosed in patent document 1, by that the respective laser light emission parts are operated in a time divisional manner synchronized with the operation of the photo detector, it can be judged on which laser resonator among the plural laser resonators (laser light emission parts) has been deteriorated.

Patent document 1: Japanese Published Patent Application No. 2004-207420

### DISCLOSURE OF THE INVENTION

### Problems to be Solved by the Invention

In the laser picture formation device as described above, however, when the laser outputs from the respective laser light emission parts are varied in a time divisional manner while an image display is being carried out, the entire light quantity would vary, thereby varying the brightness of images and occurring deteriorations in images (brightness variations in images).

The present invention is directed to solving the problems described above, and has for its object to provide a laser picture formation device which can detect the laser light outputs from the respective laser light emission parts without providing photo detectors for respective laser light emission parts, and also without generating deteriorations in images.

### Measures to Solve the Problems

In order to solve the above-described problems, according to claim 1 of the present invention, there is provided a laser picture formation device which is provided with a plurality of laser light sources, each of which produces a monochromatic light from a plurality of laser lights which are emitted from a plurality of laser light emitting parts, and the respective monochromatic lights from the plurality of laser lights being irradiated to spatial light modulators thereby to form video images, wherein the respective laser light sources which output respective monochromatic lights among the plurality of laser light sources, detect the outputs of laser light which are emitted from the respective laser light emission parts on the basis of a modulation input signal for modulating the spatial light modulator, thereby to detect the deterioration in each of the laser light emission parts.

According to claim 2 of the present invention, there is provided a laser picture formation device as defined in claim 1, wherein the detection of the output of laser light emitted from each of the laser light emission parts is carried by detecting the light quantity of laser light which is outputted from each of the laser light emission parts.

According to claim 3 of the present invention, there is provided a laser picture formation device as defined in claim 1, wherein the detection of the output of laser light from each of the laser light emission parts is carried out by detecting the oscillation threshold current in each of the laser light emission parts.

According to claim 4 of the present invention, there is provided a laser picture formation device as defined in any of claims 1 to 3, wherein the detection of the output of laser light from each of the laser light emission parts is carried out with successively un-lightening the respective laser light emission parts.

According to claim 5 of the present invention, there is provided a laser picture formation device as defined in any of claims 1 to 3, wherein the detection of the output of laser light from each of the laser light emission parts is carried out by successively lightening each of the laser light emission parts.

According to claim 6 of the present invention, there is provided a laser picture formation device as defined in any of claims 1 to 3, wherein the detection of the output of laser light from each of the laser light emission parts is carried out while the spatial light modulator is shielding the laser light from each of the laser light emitting parts.

According to claim 7 of the present invention, there is provided a laser picture formation device as defined in any of claims 1 to 3, wherein the detection of the output of laser light from each of the laser light emission parts is carried out, provided with a means for shielding the laser light from passing through the spatial light modulator, while the laser light is made by the laser light shielding means so as not pass through the spatial light modulator.

According to claim 8 of the present invention, there is provided a laser picture formation device as defined in claim 6 or 7, wherein the detection of the output of laser light from each of the laser light emission parts is carried out at the time of screen switching during when images are not displayed on the screen.

According to claim 9 of the present invention, there is provided a laser picture formation device as defined in claim 6 or 7, wherein the detection of the output of laser light from each of the laser light emission parts is carried out in a time period from the rising up of power of the respective laser light sources to the initial image being displayed on the screen when the device power is turned on, or in a time period from the final image being displayed on the screen to the falling down of power of the respective laser light sources when the device power is turned off.

According to claim 10 of the present invention, there is provided a laser picture formation device as defined in claim 6 or 7, wherein the detection of the output of laser light from each of the laser light emission parts is carried out for each frame, which frame is not continuous in its image display.

According to claim 11 of the present invention, there is provided a laser picture formation device as defined in claim 6 or 7, wherein the detection of the output of laser light from each of the laser light emission parts is carried out in a time period of the total black display of screen, which is provided between the frames which are displayed into video images.

According to claim 12 of the present invention, there is provided a laser picture formation device as defined in claim 6 or 7, wherein the detection of the output of laser light from each of the laser light emission parts is carried out for the laser light of other color which is not displayed, while at least a pure color of red (R), green (G), or blue (B) is displayed.

According to claim 13 of the present invention, there is provided a laser picture formation device as defined in claim 6 or 7, wherein the detection of the outputs of laser lights from of the laser light emission parts is carried out for the laser light of other color which is not displayed, with outputting minute weak light thereof, while at least a purity color including at least red (R), green (G), or blue (B) are displayed.

According to claim 14 of the present invention, there is provided a laser picture formation device as defined in any of claims 1 to 3, wherein the detection of the output of laser light from each of the laser light emission parts is carried out at each constant time.

According to claim 15 of the present invention, there is provided a laser picture formation device as defined in any of claims 1 to 3, wherein the detection of the output of laser light from each of the laser light emission parts is carried out provided with a function of informing the detection of the output of laser light being carried out.

According to claim 16 of the present invention, there is provided a laser picture formation device as defined in any of claims 1 to 3, wherein the detection of the output of laser light from each of the respective laser light emission parts is carried out in a state where the respective laser tight emission parts are controlled under the constant current control (ACC).

According to claim 17 of the present invention, there is provided a laser picture formation device as defined in any of claims 1 to 3, wherein the detection of the output of laser light from each of the laser light emission parts is carried out in a state where the respective laser light emission parts are controlled under the automatic power control (ACC) having a time constant that is longer than the set time for outputting the laser light.

According to claim 18 of the present invention, there is provided a laser picture formation device as defined in any of claims 1 to 17, wherein the detection of the outputs of laser light from each of the laser light emission parts is carried out, when more than one laser light emission parts among the plural laser light emission parts for which the laser driving currents are set at predetermined laser driving current values have exceeded the predetermined laser driving current value.

According to claim 19 of the present invention, there is provided a laser picture formation device as defined in any of claims 1 to 17, wherein the detection of the output of laser light from each of the laser light emission parts is carried out when the sum of the laser light outputs which are obtained from the respective laser light emission parts for which the laser light outputs of monochromatic light outputted therefrom are set at predetermined output values has become a value smaller than the predetermined output value.

According to claim 20 of the present invention, there is provided a laser picture formation device as defined in any of claims 1 to 19, wherein the detection of the output of laser light from each of the laser light emission parts is carried out with employing a photo detector for each of the laser light sources which respectively output monochromatic lights.

According to claim 21 of the present invention, there is provided a laser picture formation device as defined in any of claims 1 to 20, wherein the plurality of laser light sources include at least three laser light sources of red (R), green (G), and blue (B).

### EFFECTS OF THE INVENTION

According to the laser picture formation device of the present invention, there is provided a laser picture formation device which is provided with a plurality of laser light sources, each of which produces a monochromatic light from a plurality of laser lights which are emitted from a plurality of laser light emitting parts, and the respective monochromatic lights from the plurality of laser lights being irradiated to spatial light modulators thereby to form video images, wherein the respective laser light sources which output respective monochromatic lights among the plurality of laser light sources, detect the outputs of laser light which are emitted from the respective laser light emission parts on the basis of a modulation input signal for modulating the spatial light modulator, thereby to detect the deterioration in each of the laser light emission parts. Therefore, the deterioration situation of the respective laser light emitting parts can be confirmed without deteriorating the images which are projected onto the screen for the detection of the laser light outputs, as well as without separating the synthesized lights respectively.

Further, by detecting the deteriorations in the respective laser light emission parts during displaying video images, the deteriorations in the respective laser light emission parts can be discovered earlier, and even when the temperature rise in the laser light emission parts occurs during when the video images are displayed, or when the laser light emitting parts under lightening suddenly become faulty, it can be prevented that those portions serve as thermal sources and thereby other normal laser light emission parts would be even deteriorated.

Further, according to the laser picture formation device of the present invention, the detection of the output of laser light from each of the laser light emission parts is carried out by successively un-lightening or lightening the laser light emission parts, the detection can be carried out by a single detector, and thereby it is possible to reduce the number of the detectors used.

According to the laser picture formation device of the present invention, the detection of the output of laser light from each of the laser light emission parts is carried out when more than one laser light emission parts among the plural laser light emission parts have exceeded the predetermined laser driving current values which are previously set for the respective laser light emission parts. Therefore, by performing the detection of the output of laser light only when there is abnormality in the laser light emission part, the number of times of detection of the laser light outputs can be reduced, and the loads to the laser light emission parts can be reduced.

According to the laser picture formation device of the present invention, the detection of the output of laser light from each of the laser light emission parts is carried out for the laser light of other color which is not displayed when at least a pure color of red (R), green (G), or blue (B) is displayed. Therefore, the deterioration situation of the respective laser light emitting parts can be confirmed even without inserting the total black display appropriately, and also without deteriorating the video images projected onto the screen for the detection of the laser light output.

### BRIEF DESCRIPTION OF THE DRAWINGS

FIG. 1 is a schematic construction diagram illustrating a laser picture formation device according to a first embodiment of the present invention.

FIG. 2 is a schematic construction diagram illustrating a multi-stripe semiconductor laser optical system in the laser picture formation device of the first embodiment.

FIG. 3 is a diagram illustrating an example in which the laser lights from the respective stripes are detected with successively un-lightening the laser outputs in the first embodiment of the present invention.

FIG. 4 is a diagram illustrating an example in which the laser lights from the respective stripes are detected with successively lightening the laser lights in the first embodiment of the present invention.

FIG. 5 is a schematic construction diagram illustrating a multi-stripe semiconductor laser optical system in the laser picture formation device according to a second embodiment of the present invention.

FIG. 6 is a diagram for explaining an algorithm of the output detection method in the laser picture formation device of the second embodiment of the present invention.

FIG. 7 is a schematic construction diagram illustrating a laser picture formation device according to a third embodiment of the present invention.

FIG. 8 is a schematic construction diagram illustrating an example in which a color wheel is employed in the laser picture formation device of the third embodiment of the present invention.

FIG. 9 is a diagram illustrating a color wheel employed in the laser picture formation device as shown in FIG. 8.

FIG. 10 is a diagram illustrating an alternative of the color wheel as shown in FIG. 9.

FIG. 11 is a schematic construction diagram illustrating a laser picture formation device according to the prior art.

### DESCRIPTION OF REFERENCE NUMERALS

1 . . . laser light source
1a . . . red laser light source
1b . . . green laser light source
1c . . . blue laser light source
2 . . . expander optical system
3 . . . integrator optical system (uniform lighting optical system)
4a, 4b, 4c . . . field lens
5, 5a, 5b, 5c . . . spatial light modulator
6 . . . dichroic prism
7 . . . projection Lens
8 . . . screen
9a, 9b, 9c . . . light collection lens
10a, 10b, 10c . . . diffusion plate
11a, 11b, 11c . . . mirror
12a, 12b, 12c . . . photo detector
13 . . . color wheel
21 . . . multi-stripe semiconductor laser
21a˜21g . . . electrode of each stripe
23 . . . control circuit
24 . . . lens
26 . . . synthesized light
31 . . . detection region including deteriorated portion
51 . . . drive current meter
52 . . . output detector circuit
53 . . . switch SW
54 . . . APC circuit
101a . . . red laser light source
101b . . . green laser light source
101c . . . blue laser light source
102 . . . expander optical system
103 . . . integrator optical system
104a, 104b, 104c . . . field lens
105a, 105b, 105c . . . spatial optical modulator
106 . . . dichroic prism
107 . . . projection lens
108 . . . screen
109a, 109b, 109c . . . light collection lens
110 . . . vibrating motor

### BEST MODE FOR CARRYING OUT THE INVENTION

Hereinafter, a first embodiment of the present invention will be described with reference to the drawings.

### First Embodiment

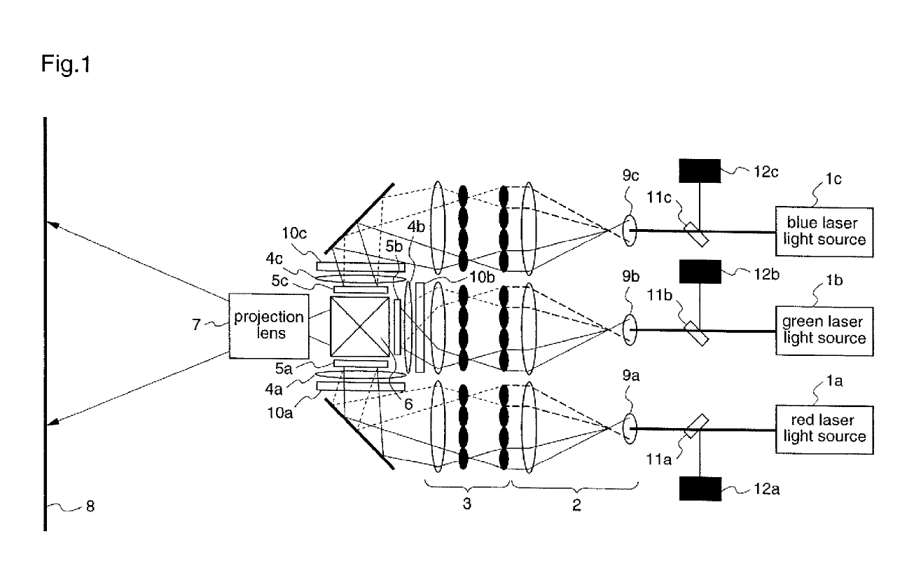

FIG. 1 is a schematic construction diagram illustrating a laser picture formation device according to a first embodiment of the present invention.

In FIG. 1, the lights which are emitted from red laser light source 1a, green laser light source 1b, and blue laser light source 1c are collected by the collection lenses 9a, 9b, 9c, respectively, and the collected lights are made pass through an expander optical system 2 and an integrator optical system (providing uniform illumination) 3 thereby being subjected to beam formation into a uniform light intensity distribution, and the resulted lights are irradiated to the dispersion plate 10a, 10b, and 10c, respectively, for removal of speckle noises. The laser lights which are dispersed by the dispersion plates 9a, 9b, and 9c, respectively, irradiate the spatial light modulator 5a, 5b, and 5c which are constituted for example by such as liquid crystal panels, thereby to produce two-dimensional images. The lights which have passed through the special optical modulators 5a, 5b, and 5c are synthesized by the dichroic prism 6, and is projected onto the screen 8 by the projection lens 7. The field lenses 4a, 4b, and 4c are operated to convert the lights which have passed through the spatial light modulators 5a, 5b, and 5c into collected light beans so that the collected light beams efficiently pass through the aperture of the projection lens 7.

Further, in the laser picture formation device of this first embodiment, the laser light sources 1a, 1b, and 1c are respectively provided with photo detectors 12a, 12h, and 12c, and mirrors 11a, 11b, and 11c of low reflectivity which reflects the laser lights from the respective laser light sources 1a, 1b, and 1c toward the respective light detectors 12a, 12b, and 12c, respectively.

In addition, the laser light sources 1a, 1b, and 1c have plural laser light emission parts, respectively, and they obtain monochromatic light respectively by synthesizing the laser lights from the respective plural laser light emission parts together.

Next, the method of detecting the outputs from the respective laser light emission parts in the laser picture formation device according to the first embodiment will be described.

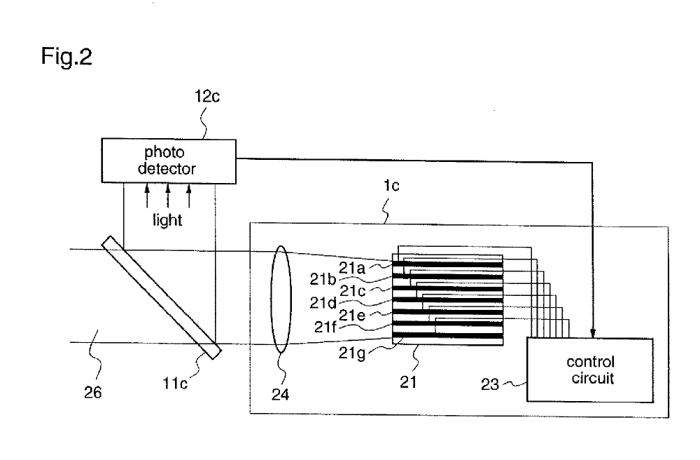

In this first embodiment, in order to simplify the explanation, an example of detecting the output of the blue laser light source 1c shown in FIG. 1 will be described with employing a conceptual diagram having extracted the optical system of blue laser light source 1c in FIG. 1 as shown in FIG. 2.

The blue laser light source 1c includes a plurality of laser light emission parts which include laser resonators respectively so as to cope with a laser picture formation device of a high brightness. In this first embodiment, a multi-stripe semiconductor laser 21 which is capable of outputting high power signals and has seven multiple stripes as the plural laser light emission parts is employed.

As shown in FIG. 2, control electrodes 21a to 21g are respectively applied on the respective stripes of the multi-stripe semiconductor laser 21, and the injection currents which are injected into the respective stripes are controlled by the current control circuits (not shown) which are included in the control circuit 23, respectively. Further, a lens 24 for synthesizing the seven light beams is provided in the vicinity of the output facet of the multi-stripe semiconductor laser 21, thereby the plural laser beams are synthesized and is reflected by the low reflectivity mirror 11c or a beam splitter, and the output of the synthesized beam is detected by one photo detector 12c and is fed back to the control circuit 23.

In the blue laser light source 1c of the above construction, the detection of the output of laser light from the respective stripes is carried out in such a manner that the total light quantity which are emitted from the multi-stripe semiconductor laser 21 is detected by the photo detector 12c, and then the light quantity of the respective laser lights which are emitted from the respective stripes are detected. In addition, the detection of the light quantity of the respective laser lights is carried out with switching the control of the semiconductor laser from the constant output power control (APC) to the constant current control (ACC).

In the first embodiment, the detection of the laser light outputs from the respective stripes are carried out in a state where the two-dimensional spatial light modulators shield the lights respectively, and the video images are not displayed on the screen. Liquid crystal panels are employed for the two dimensional spatial light modulators, video images of 30 frames per second are produced by the liquid crystal panel, and one frame among the 30 frames is set to a so-called total black display in which the lights are shielded by the respective liquid crystal panels. The total black display is carried out with modulating the liquid crystal panels according to a modulation input signal for modulating the liquid crystal panels so as to shield all the laser lights of red, green, and blue during a period of 1/30 second among 1 second. Then, during a time period of 1/30 second which is one frame period during which the total black display is carried out, the laser lights which are emitted from the respective stripes are synthesized together, and the respective laser powers are detected thereby to confirm the deterioration circumstances of the laser resonators in the respective stripes. Even when the screen is in a state of the total black display during a period of 1/30 second which is a one frame time as described above, there is no possibility of giving a sense of discomfort due to such as variations in brightness to the human eyes. Therefore, by confirming the deterioration circumstances in the respective laser resonators during while the screen is in the state of the total black display, it is possible to carry out the detection of the outputs of laser light sources, without occurring deterioration in the video images.

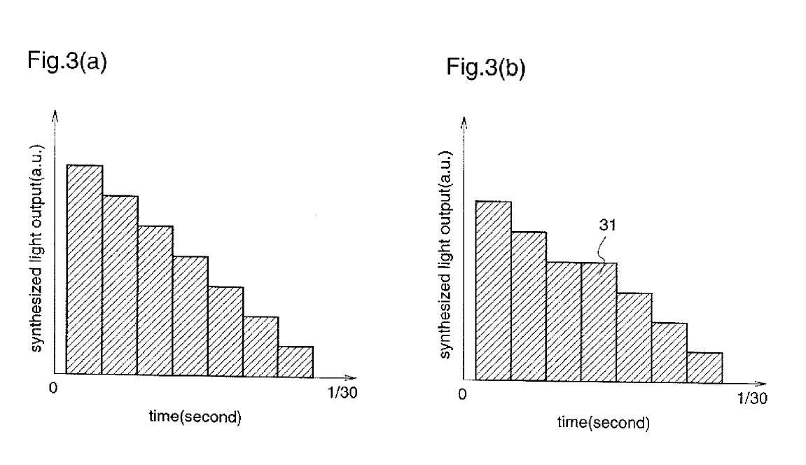

Next, the detection of deterioration in the respective laser light emission parts will be described with reference to FIG. 3.

FIG. 3 is a diagram illustrating the detection of the light outputs of the respective stripes of the multi-stripe semiconductor laser that is carried out under the constant current control (ACC) in the laser picture formation device of the first embodiment.

In order to detect the respective laser outputs of the seven stripes during a period of 1/30 second in which the total black display is being carried out, the stripes may be successively lightened or un-lightened such that each stripe is lightened or un-lightened during a period of 1/210 second. In this first embodiment, the seven stripes are successively un-lightened one by one stripe in the period of 1/30 second.

Then, the photo detector 12c can detect which stripe's output is detected by taking synchronization with the timing of un-lightening. Then, it is possible to obtain the light quantity that is generated from each of the stripes from the output power reduction amount due to the un-lightening. FIG. 3(a) shows a case where the seven stripes are normally operated, and FIG. 3(b) shows a case where one among the stripes is deteriorated.

When the stripes are normally operated, the light outputs of the respective stripes are equal to each other, and at each time the respective stripes successively un-lightened, the light output would be successively reduced by equal amounts as shown in FIG. 3(a). On the other hand, when one among the stripes is deteriorated, there occurs a detection region 31 where the reduction light amount is less or zero when the successive un-lightening is carried out as shown in FIG. 3(b). In this way, it is possible to confirm the deterioration circumstances of the stripes by successively un-lightening the respective stripes.

In addition, since the light outputs of the respective stripes are fed back to the control circuits 23 and the laser driving current values of the respective stripes are controlled by the control circuit 23, the total light quantity of the multi beams which are outputted from the seven stripes of the multi-stripe semiconductor laser 21 can be held at constant.

In this way, by employing the laser picture formation device of this first embodiment, it is possible to monitor the light outputs of the respective stripes of the laser light sources simultaneously while offering vivid video images having no brightness change to the viewers, thereby resulting in quite an effective device.

As described above, in the laser picture formation device according to the first embodiment of the present invention which, provided with plural laser light sources 1a, 1b, and 1c which respectively obtain monochromatic lights from plural laser lights which are emitted from plural laser light emission parts, irradiates the respective lights of monochromatic light emitted from the plural laser lights to the spatial light modulators 5a, 5b, and 5c thereby to form video images, each of the laser light sources 1a, 1b, and 1c which output monochromatic lights respectively is operated to detect the laser light output which is emitted from each of the laser light emission parts on the basis of the modulation input signal for modulating the spatial light modulators 5a, 5b, and 5c, and thereby the deterioration in the respective laser light output parts are detected. Therefore, it is possible to detect the laser light outputs from the respective laser light emission parts without the necessity of providing detectors for the laser light emission parts respectively, and further without generating deterioration in the video images. In other words, the total black display of 1/30 second which does not give a sense of discomfort such as brightness variation to the human eyes is carried out during a period of 1 second video image display, thereby it is possible to confirm the deterioration situations of the respective laser light emission parts which are possessed by the respective laser light sources 1a, 1b, and 1c without halting the video images which are projected onto the screen for the detection of the laser lights, as well as without separating the synthesized light respectively.

In addition, by detecting the deterioration in the respective laser light emission parts during displaying the video images, it is possible to find the deterioration in the respective laser light emission parts at earlier stages, and thereby, even when the temperature rise of the laser light emission parts occurs or the laser light emission parts under the lighting suddenly fall in into faulty states during displaying the video images, it is possible to prevent the other normal laser light emission parts from being deteriorated with those portions serving as thermal sources.

In addition, since in the laser picture formation device of the first embodiment the detection of the laser light outputs from the respective stripes is carried out in a time divisional manner in each of the laser light sources 1a, 1b, and 1c, it is possible to detect the laser light output from the respective stripes by a single detector for each laser light source, and thereby the number of the detectors used can be reduced.

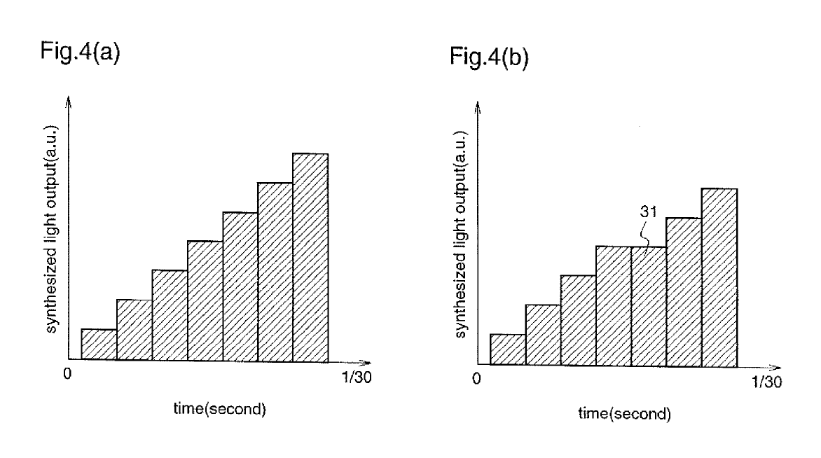

In addition, while in the above-described first embodiment the detection of the output for the multi-stripe semiconductor laser is carried out with successively un-lightening one by one stripe of the multi-stripe semiconductor laser, the detection of the laser light output of the respective laser light emission parts can be carried out with successively lightening one by one stripe as shown in FIG. 4.

In addition, while in the above-described embodiment, the detection of the output is carried out utilizing a time period of 1/30 second of one frame among the video image display of 30 frames per second, the detection of the output may be carried out at timings of such as screen switching during when no video images are displayed on the screen. For example, the detection of the output may be carried out at the power rising of the device during when no video images are displayed on the screen. Further, the detection of the output may be carried out at the power failing of the device during when no video images are displayed on the screen. Further, the detection of the output may be carried out at the period of the total back display that is provided between the video image display frames so as to prevent afterimages occurring due to the delay in response speed of the liquid crystal panel.

While in the first embodiment the detection of the output is carried out by utilizing one frame among the thirty frames per second, if the detection of the output is carried out during the period of a frame which is non-continuous, it is possible to provide beautiful video images which would not occur brightness changes.

While in the first embodiment the detection of the output of the multi-stripe laser is carried out in a state where the light is shielded by the spatial light modulator and thereby the total black display is carried out on the screen, the method of shielding the light so as not to display video images on the screen is not limited thereto. For example, the total blank display onto the screen may be carried out by for example inserting another light modulator in front of the liquid crystal panel which produces video images and controlling the input to the liquid crystal panel by switching.

While in the first embodiment the detection of the output is carried out with switching the control of the semiconductor laser from the constant output power control (APC) to the constant current control (ACC), it is possible to carry out the detection of the output without dissolving the APC by setting the time constant for the APC to a time which is sufficiently longer than the time that is required for the detection of the light quantity, thereby resulting in an effective method.

While in the above first embodiment the detection of the output of laser light from the respective stripes is carried out as the detection of the laser light quantity in the respective stripes, and the deterioration judgment is carried out based on the variation in the light quantity in the respective stripes, it is not limited thereto. For example, the detection of the output of laser light from the respective stripes may be carried out by the detection of the laser oscillation threshold of the respective stripes. For example, the laser light in the respective stripes may be detected with taking the un-lightening or lightening current value as a threshold so as to carry out the deterioration judgment based on the variation in the threshold value in the respective stripes. In this case, since the threshold current would vary when there is abnormality in respective stripes, the deterioration judgment can be carried out based thereon. Thereby, the abnormality in the laser light emission part can be detected at a low output power which would not affect unfavorably on the video images, and further, the detection of the output can be carried out in a short time.

While in the above-described first embodiment, one frame among 30 frames per second is employed in the detection of the output of laser light from the respective stripes in the blue laser light source 1c, it is not limited thereto. Particularly, one frame among a predetermined number of frames may be employed in each of the colors. For example, in order to reduce the frequency of detection of the output, the detection of the output may be carried out in one frame among 60 frames, or in one frame among 90 frames.

While in the first embodiment a blue multi-stripe semiconductor laser is employed as a light source, a light source that produces a monochromatic light with employing plural resonators may be employed. For example, a light source having plural resonators, not having the plural resonators on a same substrate, such as a fiber laser or a solid state laser, may be employed. Further, while in the first embodiment the detection of the output of the blue laser light source is described, light sources which obtain a monochromatic light by synthesizing plural lights employing plural laser resonators (laser light emission parts) may be similarly employed. Particularly, the blue light source, the red light source, and the green light source are light sources dispensable for the laser picture formation device as being effective.

While in the first embodiment the detection of the output of the laser light sources and the deterioration judgment are carried out by performing the total black display of one frame during the video image display of thirty frames per second, the detection of the output of the laser light sources and the deterioration judgment may be carried out at timings of the video signal being inputted to the spatial light modulators. For example, the deterioration judgment of the respective laser light emission parts in the blue laser light source may be carried out when the video image signal of the pure color of other color (red or green) is inputted to the spatial light modulator and the other pure color (red or green) is displayed on the screen. In this method, the deterioration judgment of the laser light sources can be carried out without appropriately inserting the total black display.

While in the present invention, the detection of the output of laser light is carried out when the total black display in which no video image is displayed on the screen, if the detection of the output is carried out with a small output variation or a rapid switching time which cannot be sensed by the human eyes even when the video display is carried out on a screen, it is possible to obtain beautiful images which has no brightness reduction or flickering, while detecting the output of laser lights of the individual laser light emission parts.

### Second Embodiment

A laser picture formation device according to a second embodiment of the present invention is constructed to carry out, in order to reduce the loads to the laser light emission parts which have occurred due to that the detection of the laser outputs have been always carried out in the first embodiment, detection of the laser light output when any of the respective laser light emission parts which are possessed by the respective laser light sources is found to be abnormal or faulty.

The laser picture formation device of this second embodiment previously sets predetermined driving current values in the respective stripes of the multi-stripe semiconductor laser, and carries out detection of the laser light output when the driving current of each of the stripes has exceeded the set predetermined driving current value.

In the laser picture formation device of this second embodiment, differences from the first embodiment reside in the optical systems of the laser light sources 1a, 1b, and 1c of each color. Only the different portions will be described. The blue laser light source of FIG. 1 will be described also in this second embodiment for simplicity.

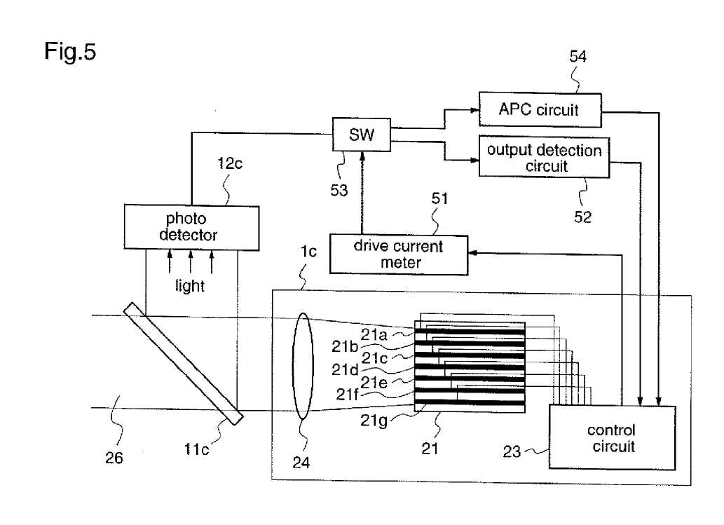

FIG. 5 is a conceptual diagram extracting the optical system of the blue laser light source 1c for illustration in the laser picture formation device of the second embodiment. The same reference numerals are used to denote the same portions as in FIG. 1.

In FIG. 5, similarly as in the first embodiment, the blue laser light source 1c employs, in order to correspond to a high brightness laser display, a GaN system multi-stripe laser 21 which can provide a high power output, as one which provides plural laser light emission parts including respectively the laser resonators, in which the number of stripes in the multi-stripes is seven. Further, as similarly in the first embodiment, control electrodes 21a to 21g are applied onto the respective stripes of the semiconductor laser, and the injection currents are controlled by the respective current control circuits (not shown) included in the control circuit 23. In addition, similarly as in the first embodiment, a synthesizing collimating lens 24 is provided at the light emission facet side of the semiconductor laser chip. This collimating lens synthesizes plural laser beams, the synthesized light is reflected by the low reflectivity mirror 11c or a beam splitter, the light quantity of the synthesized beam is detected by one photo detector 12c and is fed back to the control circuit 23.

In the second embodiment, the optical system of the blue laser light source 1c includes a driving current meter 51 which measures the driving current of the multi-stripe semiconductor laser 21 so as to switch the switch SW53 when the driving current value has exceeded a predetermined value, an APC circuit 54 which carry out an output control of the laser light from the respective stripes by a constant output power control (APC), and an output detection circuit 52 which detects that the driving current value has exceeded the predetermined value, i.e., that the switching to the output detection mode is carried out, and communicates it to the control circuit 23 as shown in FIG. 5.

While in FIG. 5, the driving current meter 51, the output detection circuit 52, the switch 53, and the APC circuit 54 are illustrated, these circuits may be provided in the control circuit 23.

Next, the method of detecting the laser light output which is emitted from the respective stripes in the laser picture formation device of this second embodiment will be described.

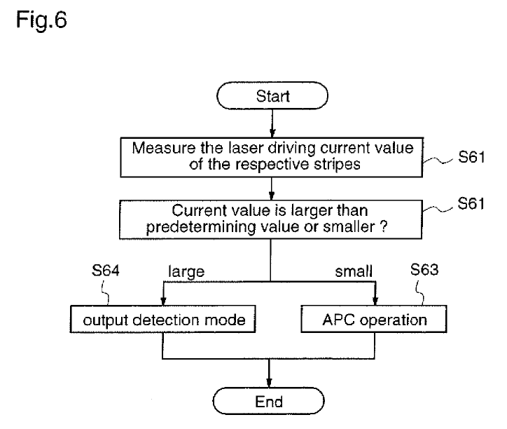

FIG. 6 illustrates a laser output detection method (in a flowchart) in the laser picture formation device of the present invention.

Herein, the algorism by which the switching to the output detection mode is carried out when any of the respective stripes of the multi-stripe semiconductor laser has exceeded the predetermined driving current value will be described.

In this second embodiment, it is assumed that the respective stripes are driven with the same driving current values respectively under the constant output power control (APC). In other words, the power control of the laser light is carried out by the constant output power control (APC), and when any of the driving current values of the stripes is varied, the driving current values would vary in all the stripes.

In addition, the driving current meter 51 has previously set equal predetermined driving current values for the respective stripes, and when the driving current values of the respective stripes exceeds the set predetermined driving current values, the switch SW53 is switched to the output detection mode.

In the second embodiment, the driving current values of the seven multi-stripe at start of driving are supposed to be all “I”, and the predetermined driving current values which are set by the driving current meter are supposed to be all “I′”.

In step S61, the currents of the respective stripes are measured by the driving current meter, and up until the driving current values of the respective stripes which have started the driving with the driving current value I exceed in step S62 the driving current value I′ which is previously set, the detection of the independent laser light outputs which are outputted from the respective stripes are not carried out, while the APC operation is continued at step S63.

However, when an abnormality occurs in any of the stripes at performing the constant output power control (APC) and thereby the driving current values of the respective stripes exceed the predetermined driving current value I′ in step S62, it is judged by the driving current meter 51 as having exceeded the predetermined driving current value. Then, while it is not possible to judge in which stripe there occurred abnormality because the respective driving current values of the seven stripes all exceed I′, it can be judged as there has occurred abnormality in any of the seven stripes. Then, in order to enable to judge which stripe has occurred the abnormality among the seven stripes, the switch SW53 is switched to the laser light output detection mode by the driving current meter 51 in step S64. In other words, while the feedback from the photo detector 12c passes through the APC circuit 54 in the normal operation, it is switched so that it does not pass through the APC circuit 54 but pass through the output detection circuit 52 in the laser output detection mode.

When the switch SW53 is switched, the output detection circuit 52 communicates to the control circuit 23 as being in the output detection mode for detecting the laser lights of the respective stripes, and thereby enters the output detection mode for detecting the laser lights of the respective stripes. As the timings for detection in the laser output detection mode, the detection of the outputs for the respective laser lights of the seven stripes are carried out during the screen is in the total black display with the lights being shielded by liquid crystal panels similarly as in the first embodiment. The method of detecting the output is the same as in the first embodiment, and the description will be omitted.

In this way, since the detection of the output of laser light is carried out only when there are abnormality in any of the seven stripes, there is no necessity of detecting the laser light output when the resonators of the respective stripes are normal, and thereby the detection of the laser light output of a high efficiency can be carried out.

As described above, according to the laser picture formation device of the second embodiment, the predetermined driving current values of the respective stripes of the multi-stripe semiconductor laser 21 are previously set, and when any of the stripes has exceeded the predetermined driving current value, it is judged as any of the stripes being abnormal or faulty, to carry out switching to the output detection mode. Therefore, there is no necessity of repeating lightening or un-lightening of lasers with a predetermined period as in the first embodiment, and thereby the loads applied to the resonators due to turning ON or OFF of the lasers can be reduced, as being quite effective.

While in the above-described second embodiment, reference values are previously set for the power of the synthesized light and it is switched to the output detection mode when the abnormality has occurred, the reference items other than the laser driving current values of the respective stripes may be set. For example, it may be constructed such that predetermined set values are previously set for the output which is synthesized from the laser lights from the respective stripes at performing the constant current control (ACC), and when the monitored synthesized output which is the sum of the outputs obtained from the respective stripes is below the predetermined value at performing the ACC, it is switched to the output detection mode.

While in the second embodiment it is switched to the output detection mode at the timing when the laser driving current value has exceeded the set value, the detection of the output may be carried out at each constant time. Further, the detection of the output can be carried out using the time period of one frame among thirty frames as in the first embodiment. In order to reduce the frequency of the detection of the output, one frame among sixty frames or one frame among ninety frames may be used.

In addition, the output detection in the output detection mode may be carried out while the video image display is once halted and the display is made the normal total black display or another display (such as one purity color display). In a laser picture formation device employing three colors of R (red), G (green), and B (blue), if the liquid crystal panel for the color R is made in the total black display to carry out the detection of the R output, and those for other two colors are made in the normal operation, the video images from the GB liquid crystal panels are projected onto the screen. Then, it may be informed to the viewer as being in the output detection mode by a video image display or sound.

While in the second embodiment a blue multi-stripe semiconductor laser is employed as a light source, a light source which produces a monochromatic light with employing plural resonators may be employed. For example, a light source having plural resonators, not having the plural resonators on a same substrate, such as a fiber laser or a solid state laser, may be employed. Further, while in the second embodiment the detection of the output of the blue laser light source is described, light sources which obtain a monochromatic light by synthesizing plural lights employing plural laser resonators (laser light emission parts) may be similarly employed. Particularly, the blue light source, the red light source, and the green light source are light sources dispensable for the laser picture formation device, as being effective.

### Third Embodiment

A image formation device according to a third embodiment of the present invention is constructed to carry out the detection of the output of the laser light source which is not displayed on the basis of the field sequential laser light emission timing so as to enable, while providing vivid images having no brightness changes or no video image deterioration, grasping the deterioration circumstances of the respective laser light sources in a laser picture formation device which forms video images by emitting laser lights from the respective laser light sources by a field sequential operation using one spatial light modulator.

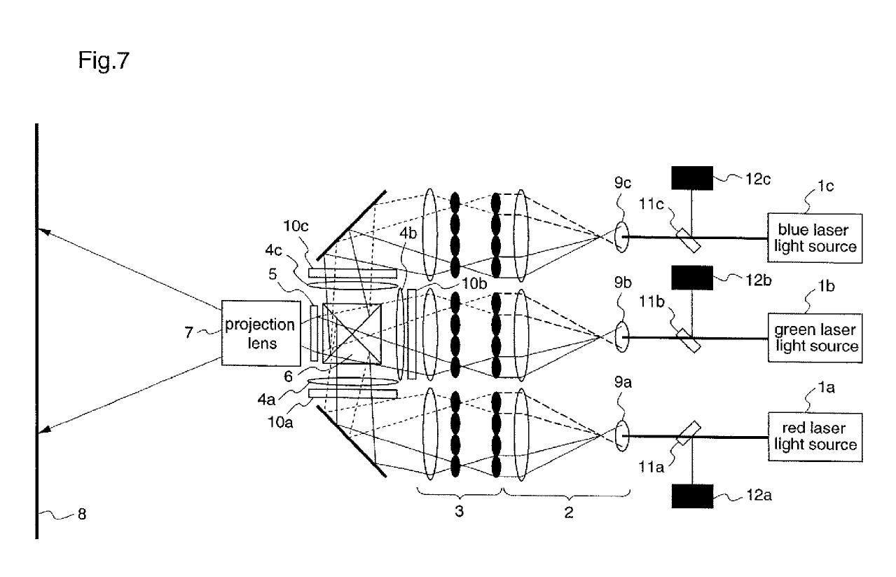

FIG. 7 is a schematic construction diagram illustrating a laser picture formation device according to the third embodiment of the present invention. The same elements as in FIG. 1 are denoted by the sane reference numerals, and description will be omitted.

In FIG. 7, the lights which are emitted from red laser light source 1a, green laser light source 1b, and blue laser light source 1c are collected by the collection lenses 9a, 9b, and 9c, respectively, and the collected lights are made pass through the expander optical system 2 and the integrator optical system 3, thereby being subjected to beam formation into a uniform light intensity distribution, and the resulted lights are irradiated to the dispersion plates 10a, 10b, and 10c, respectively, for removal of speckle noises. The laser lights which are dispersed by the dispersion plates 10a to 10c are irradiated to the spatial light modulator 5 which is a piece of liquid crystal panel through the dichroic prism 6, thereby to produce a two-dimensional image. Then, the light which has passed through the spatial light modulator 5 is projected onto the screen 8 by the projection lens 7. The field lenses 4a, 4b, and 4c are operated to convert the lights which have passed through the spatial light modulator 5 into collected light beams so that the collected light beams effectively pass through the aperture in the projection lens 7.

The laser picture formation device of this third embodiment employs the field sequential system in which a modulation input signal of a predetermined emission pattern is inputted to a spatial light modulator 5 and the spatial light modulator 5 is modulated so as to display laser lights of respective colors in accordance with the predetermined emission pattern.

In order to simplify the explanation, the method of detecting the output of the blue laser light source 1c of FIG. 7 will be described in this third embodiment. The optical system of the blue laser light source 1c has a similar construction as that of the first embodiment show in FIG. 2, and in order to cope with a laser picture formation device of a high brightness, a GaN system multi-stripe semiconductor laser 21 capable of producing a high power output is employed for the plural laser light emission parts which respectively has laser resonators, and the number stripes in the multi-stripe here is seven.

Next, the method of detecting the laser lights which are outputted from the respective stripes of the multi-stripe semiconductor laser 21 for the blue laser light source 1c in the laser picture formation device of the third embodiment will be described.

The detection of the output of the blue laser light when the spatial light modulator 5 carries out such a control that the images of other colors (red or green) are displayed on the screen will be described.

In the third embodiment, a liquid crystal panel that is common through RGB and serves as a two-dimensional spatial light modulator is employed for the spatial light modulator 5. In addition, in this third embodiment, an image of thirty frames per second is produced by a liquid crystal panel. In order to produce images of one frame, the lights of respective RGB are inputted to the spatial light modulator 5 with successively being lightened for 1/90 second, respectively. In other words, the spatial light modulator 5 divides 1/30 second as one frame time equally into three for respective color of RGB, and assigns 1/90 second to each color. In addition, the light emission timings of the respective laser light sources 1a, 1b, and 1c are synchronized with the spatial light modulator 5.

In this third embodiment, when the light emission timing due to the field sequential system is that for the irradiation of the red laser light to the spatial light modulator 5, the blue laser light from the blue laser light source 1c is lightened in minute weak light though it is not the timing when the blue laser light is emitted. Then, the output of the blue laser light is at a low power level as can be ignored compared with the red laser light. Therefore, it is possible to detect the light quantity of the respective stripes in the blue laser light source and confirm the deterioration circumstances of the respective laser resonators during when the red video images are projected onto the screen. Then, since the blue light is minute weak light, it does not give a sense of discomfort to human eyes. In this way, it is possible to carry out confirmation of the deterioration circumstances of the laser resonators of the respective stripes during when other lights are projected onto the screen by the spatial light modulator 5.

In addition, the method of detecting the output of laser light from the respective stripes in the third embodiment is the same as those in the first embodiment. However, while the outputs of the seven stripes are detected during a 1/30 second in the first embodiment, the outputs of the seven stripes are detected during a 1/90 second during when the red laser light is irradiated to the screen 8 as well as to the spatial light modulator 5 in the third embodiment. In other words, lightening or un-lightening is successively carried out in a 1/630 second per stripe, thereby enabling grasping the deterioration circumstances of the respective laser light emission parts.

In the third embodiment, the confirmation of the deterioration circumstances of the lasers is carried out by successively un-lightening the respective stripes similarly as in the first embodiment. The confirmation method of the deterioration circumstances is the same as in the first embodiment. Further, as described in the first embodiment, the deterioration circumstances by the respective stripes may be judged by detecting the oscillation thresholds of the respective stripes.

Next, an alternative example of the third embodiment in which a color wheel 13 which successively shields the lights of RGB three colors is employed in the laser picture formation device shown in FIG. 7 will be described.

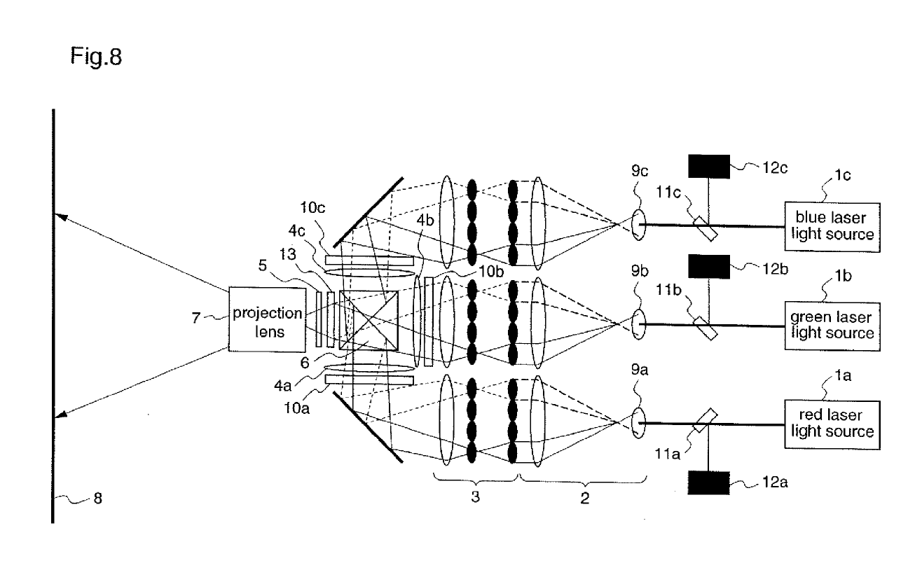

FIG. 8 is a diagram illustrating a laser picture formation device using a color wheel 13 in this third embodiment.

FIG. 8 is different from FIG. 7 in that a color wheel 13 is provided between the dichroic prism 6 and the spatial light modulator 5. Therefore, the light from the dichroic prism 6 passes through the color wheel 13, and then, it is irradiated to the spatial light modulator which comprises a piece of liquid crystal panel.

In addition, similarly as in the example of FIG. 7, the field sequential system is employed, in which a modulation input signal of a predetermined emission pattern is inputted to a spatial light modulator 5 and the spatial light modulator 5 is modulated so as to display laser lights of respective colors in accordance with the predetermined emission pattern.

Next, the method of detecting the laser light outputs which are outputted from the respective stripes of the multi-stripe semiconductor laser 21 for the blue laser light source 1c in the laser picture formation device employing the color wheel 13, as the alternative of the third embodiment, will be described.

The detection of the output of the blue laser light when the spatial light modulators 5 carry out a control for displaying the video images of other colors (red or green) on the screen will be described.

When the color wheel 13 is employed in the third embodiment, the light of RGB three colors are successively shielded for a piece of liquid crystal panel 5 by rotating the color wheel, thereby to produce a video image with synchronizing with the open or close of the liquid crystal panel (spatial light modulator 5).

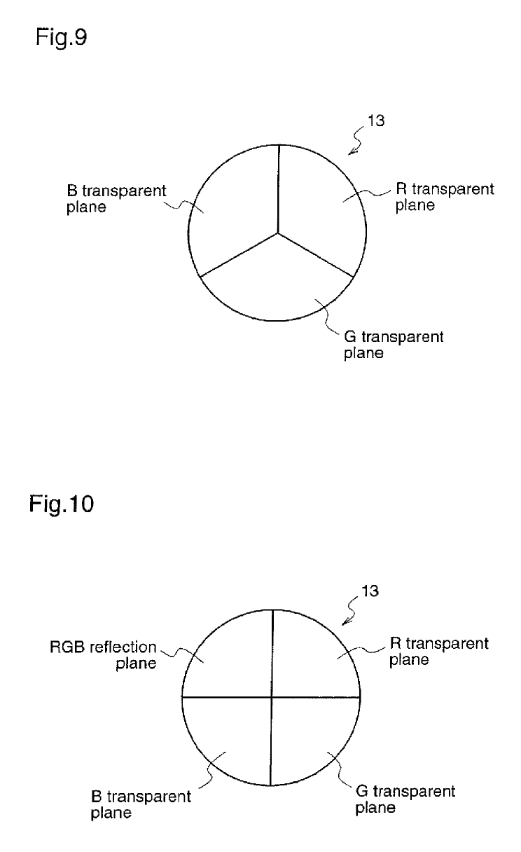

In addition, it is supposed that the video image of thirty frames per second is produced by the liquid crystal panel 5. In order to produce the video image of one frame, the respective RGB lights pass through the color wheel 13 only for one color for 1/90 second, and the other two colors are shielded to be incident to the liquid crystal panel 5. The color wheel 13 is produced in a circular plate in its entirety as shown in FIG. 9, and transparent planes for making each of the R, G, and B colors pass through are provided for respective 120 degrees. More particularly, the 1/30 second as one frame time is equally divided into three for respective RGB three colors, and each divided 1/90 second is assigned to each color.

For example, when only the red color light is made pass through the color wheel 13 at a light emission timing and the red color light is irradiated to the liquid crystal panel, the blue color light and the green color light are reflected by the color wheel 13 and are not irradiated to the liquid crystal panel. In other words, in such case, even if the output power is varied in the detection of the outputs of blue light and green light, the video images which are projected onto the screen are not disturbed. Therefore, it is possible to detect the light quantity of the respective laser light emission parts in the blue laser light source and thereby to confirm the deterioration circumstances of the respective laser light emission parts, while the red video image is projected onto the screen. Thereby, it is possible to confirm the deterioration circumstances in the respective resonators of the blue laser light source without making the laser light minute weak light when the red light which has passed through the color wheel is projected onto the liquid crystal panel. Herein, the method of detecting the output of laser light is similar to that in the first embodiment.

As described above, according to the third embodiment, there is provided a laser picture formation device in which a spatial light modulator is employed, the spatial light modulator is modulated by the field sequential system to emit the respective RGB laser lights, and in which each of the laser light sources (1a, 1b, and 1c) emits minute weak light to carry out the detection of its laser light output while laser lights are emitted from other laser light sources. Thereby, even when the video image display is carried out by successive lightening the respective colors, it is possible to carry out grasping of the deterioration circumstances of respective stripes of the laser light sources simultaneously with offering vivid video images which has no brightness deterioration or no video image deterioration, as being quite effective.

In addition, when the color wheel 13 is employed, each of the laser light sources (1a, 1b, and 1c) carries out detection of its laser light output while the laser lights from the other laser light sources are emitted passing through the color wheel 13. Therefore, it is possible to carry out the detection of the output without making the laser light minute weal light.

While in the above-described third embodiment the detection of the output is carried out with un-lightening the multi-stripe semiconductor laser one by one stripe, the deterioration circumstances of the respective resonators may be grasped with successively lightening the respective stripes.

In addition, while in the third embodiment grasping of the deterioration circumstances of the respective laser light emission parts of the blue laser are carried out, the similar methods may be employed for grasping the deterioration circumstances of the respective laser light emission parts also for the green laser and the red laser which are respectively constituted by plural laser light emission parts.

While in the third embodiment the respective laser light sources 1a, 1b, and 1c carries out the detection of the laser light outputs when the laser light outputs are emitted, the period of detecting the output are arbitrary. In addition, similarly as in the second embodiment, it may be made as the output detection mode when any of the plural laser light emission parts has abnormality.

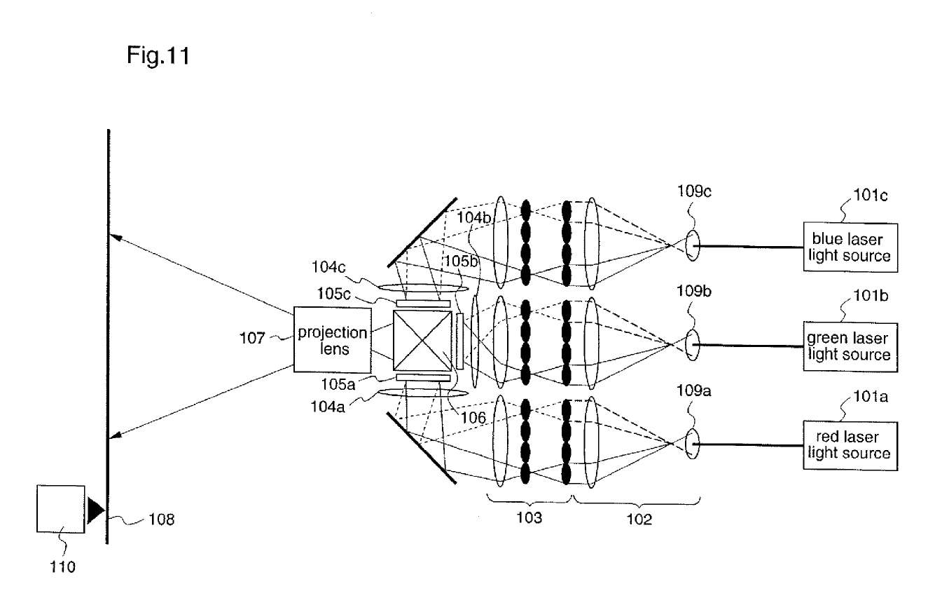

In addition, while in the third embodiment the successive lightening of the RGB laser light sources are carried out without providing blanking of video images, it may be constructed such that the blanking are inserted into the output timings in the field sequential system and the deterioration judgment of the respective laser light emission parts may be carried out with successively lightening or successively un-lightening the respective laser light emission parts in the respective laser light sources. When the black display is carried out at blanking, since the video images are not projected onto the screen, it is possible to carry out the power detection even when it is not minute weak light. This video image blanking can be produced by closing the liquid crystal panel. Also when the color wheel is employed, this video image blanking can be produced by providing RGB reflection planes which reflect all the lights of RGB with the color wheel as shown in FIG. 10. Since the video images are not projected onto the screen in the blanking, it is possible to carry out the power detection of the respective RGB laser lights without disturbing the video images. Further, when the color wheel is not employed, the power detection outside the video image blanking period has to be carried out with minute weak light.

While in the above-described third embodiment the laser is emitted with minute weak light and the deterioration judgment is carried out with that output power, the deterioration judgment can be carried out by measuring the oscillation threshold currents of the respective laser resonators.

While in the third embodiment a blue multi-stripe semiconductor laser is employed as a light source, a light source which produces a monochromatic light employing plural resonators may be employed. For example, a light source having plural resonators, not having the plural resonators on a same substrate, such as a fiber laser or a solid state laser, may be employed. Further, while in the third embodiment the detection of the output of the blue laser light source is described, light sources which obtain a monochromatic light by synthesizing plural lights employing plural laser resonators (laser light emission parts) may be similarly employed. Particularly, the blue light source, the red light source, and the green light source are light sources dispensable for the laser picture formation device, as being effective.

While in the first to the third embodiments low reflectivity mirrors are disposed at the laser light emission facet sides and the synthesized power is detected by a detection monitor, the detection monitor may be disposed at the facet opposite to the laser light emission facet to carry out the power detection. In this case, since it is possible to avoid the laser power reduction due to low reflectivity mirrors, the video images which are projected onto the screen becomes of higher brightness, resulting in more effectiveness.

In the illustrated first to third embodiments, the laser light sources of RGB three colors are illustrated, this is not limited thereto. The present invention is also effective in a laser light source of employing more than four laser light sources.

While in the illustrated first to third embodiments, a multi-stripe semiconductor laser having seven stripes is illustrated, this is not limited thereto. Those which have stripes of the number that can carry out the detection of laser light outputs without deteriorating the video images are effective in the present invention.

### APPLICABILITY IN INDUSTRY

According to the laser picture formation device of the present invention, it is possible to detect the deterioration circumstances of the respective resonators without stopping the video images which are projected onto the screen for the detection of the outputs as well as without separating the synthesized light respectively. Further, since the detection is carried out after the output lights are synthesized, it is possible to carry out the detection only by a single detector, and thus the number of detectors can be reduced, as particular effects of the present invention. Thus, the present invention is quite effective as a laser picture formation device which forms a video image using light sources which detect and control the light quantity of the plural laser beams which are emitted from plural lasers.

1. A laser picture formation device which is provided with a plurality of laser light sources, each of which produces a monochromatic light from a plurality of laser lights which are emitted from a plurality of laser light emitting parts, and the respective monochromatic lights from the plurality of laser lights being irradiated to spatial light modulators thereby to form video images, wherein
the respective laser light sources which output respective monochromatic lights among the plurality of laser light sources, detect the outputs of laser light which are emitted from the respective laser light emission parts on the basis of a modulation input signal for modulating the spatial light modulator, thereby to detect the deterioration in each of the laser light emission parts.

2. A laser picture formation device as defined in claim 1, wherein;
the detection of the output of laser light from each of the laser light emission parts is carried out by detecting the light quantity of laser light which is outputted from each of the laser light emission parts.

3. A laser picture formation device as defined in claim 1 wherein
the detection of the output of laser light from each of the laser light emission parts is carried out by detecting the oscillation threshold current in each of the laser light emission parts.

4. A laser picture formation device as defined in claim 1, wherein
the detection of the output of laser light from each of the laser light emission parts is carried out with successively un-lightening the respective laser light emission parts.

5. A laser picture formation device as defined in claim 1, wherein
the detection of the output of laser light from each of the laser light emission parts is carried out with successively lightening the respective laser light emission parts.

6. A laser picture formation device as defined in claim 1, wherein
the detection of the output of laser light from each of the laser light emission parts is carried out while the spatial light modulator is shielding the laser lights from the respective laser light emitting parts.

7. A laser picture formation device as defined in claim 1, wherein
the detection of the output of laser light from each of the laser light emission parts is carried out, provided with a means for shielding the laser light from passing through the spatial light modulator, while the laser light is made by the laser light shielding means so as not pass through the spatial light modulator.

8. A laser picture formation device as defined in claim 6, wherein
the detection of the output of laser light from each of the laser light emission parts is carried out at the time of screen switching during when images are not displayed on the screen.

9. A laser picture formation device as defined in claim 6,
wherein the detection of the output of laser light from each of the laser light emission parts is carried out in a time period from the rising up of power of the respective laser light sources to the initial image being displayed on the screen when device power is turned on, or in a period from the final image being displayed on the screen to the falling down of power of the respective laser light sources when the device power is turned off.

10. A laser picture formation device as defined in claim 6, wherein
the detection of the outputs of laser lights from each of the laser light emission parts is carried out for each frame, which frame is not continuous in its image display.

11. A laser picture formation device as defined in claim 6, wherein
the detection of the outputs of laser lights from each of the laser light emission parts is carried out in a time period of the total black display of screen, which is provided between the frames which are displayed into video images.

12. A laser picture formation device as defined in claim 6, wherein
the detection of the output of laser light from each of the laser light emission parts is carried out for the laser light of other color which is not displayed, while at least a pure color of red (R), green (G), or blue (B) is displayed.

13. A laser picture formation device as defined in claim 1, wherein
the detection of the output of laser light from each of the laser light emission parts is carried out for the laser light of other color which is not displayed, with outputting minute weak light thereof, while at least a pure color of red (R), green (G), or blue (B) is displayed.

14. A laser picture formation device as defined in claim 1, wherein
the detection of the output of laser light from each of the laser light emission parts is carried out at each constant time.

15. A laser picture formation device as defined in claim 1, wherein
the detection of the output of laser light from each of the laser light emission parts is carried out provided with a function of informing the detection of the output of laser light being carried out.

16. A laser picture formation device as defined in claim 1, wherein
the detection of the output of laser light from each of the laser light emission parts is carried out in a state where the respective laser light emission parts are controlled under the constant current control (ACC).

17. A laser picture formation device as defined in claim 1, wherein
the detection of the outputs of laser light from each of the laser light emission parts is carried out in a state where the respective laser light emission parts are controlled under the constant output power control (APC) having a time constant that is longer than the set value for outputting the laser light.

18. A laser picture formation device as defined in claim 1, wherein
the detection of the output of laser light from each of the respective laser light emission parts is carried out, when more than one laser light emission parts among the plural laser light emission parts for which the laser driving currents are set at predetermined laser driving current values have exceeded the predetermined laser driving current value.

19. A laser picture formation device as defined in claim 1, wherein
the detection of the outputs of laser lights from each of the laser light emission parts is carried out when the sum of the laser light outputs which are obtained from the respective laser light emission parts for which the laser light outputs of monochromatic light outputted therefrom are set at predetermined values has become a value smaller than the predetermined output value.

20. A laser picture formation device as defined in claim 1, wherein
the detection of the output of laser light from each of the laser light emission parts is carried out with employing a photo detector for each of the laser light sources which respectively output monochromatic lights.

21. A laser picture formation device as defined in claim 1, wherein
the plurality of laser light sources include at least three laser light sources of red (R), green (G), and blue (B).

22. A laser picture formation device as defined in claim 7, wherein
the detection of the output of laser light from each of the laser light emission parts is carried out at the time of screen switching during when images are not displayed on the screen.

23. A laser picture formation device as defined in claim 7, wherein
the detection of the output of laser light from each of the laser light emission parts is carried out in a time period from the rising up of power of the respective laser light sources to the initial image being displayed on the screen when device power is turned on, or in a period from the final image being displayed on the screen to the falling down of power of the respective laser light sources when the device power is turned off.

24. A laser picture formation device as defined in claim 7, wherein
the detection of the outputs of laser lights from each of the laser light emission parts is carried out for each frame, which frame is not continuous in its image display.

25. A laser picture formation device as defined in claim 7, wherein
the detection of the outputs of laser lights from each of the laser light emission parts is carried out in a time period of the total black display of screen, which is provided between the frames which are displayed into video images.

26. A laser picture formation device as defined in claim 7, wherein
the detection of the output of laser light from each of the laser light emission parts is carried out for the laser light of other color which is not displayed, while at least a pure color of red (R), green (G), or blue (B) is displayed.
